(19) United States
(12) Patent Application Publication
(10) Pub. No.: US 2004/0043373 A1
(43) Pub. Date: Mar. 4, 2004

(54) System for providing computer-assisted development

(76) Inventor: Jeffrey M. Kaiserman, St. Louis Park, MN (US)

Correspondence Address: BRINKS HOFER GILSON & LIONE, ONE INDIANA SQUARE, SUITE 1600, INDIANAPOLIS, IN, 46204, US

(21) Appl. No.: 10/234,610

(22) Filed: Sep. 4, 2002

(51) Int. Cl. G09B 3/00

(52) U.S. Cl. 434/350

(57) ABSTRACT

A development system for providing computer-assisted development of a user includes a central computer and an intelligent companion (IC) computer. The IC computer operates with program content to provide dynamic interactive behavior towards the user. Interaction between the user and the IC computer may be captured by the IC computer as interaction data. Upon selective communication with the central computer, the interaction data may be transferred to the central computer for analysis. Based on the analysis, the central computer may generate program information. Program information may be transferred to the IC computer to customize the program content and enhance the development of the user. In addition, the central computer may provide developmental results in the form of reports, archived data and trends related to user performance for use by administrators of the user's development.

### FIELD OF THE INVENTION

The instant invention relates generally to computer-assisted development, and more particularly to a system for computer-assisted development of a user utilizing an intelligent companion computer.

### BACKGROUND

In general, children of all ages are more relaxed when they are alone playing with their toys than they are around their parents and teachers. Children are also more apt to learn material that they are repeatedly exposed to over an extended period of time. Given the limited opportunities that young children have to receive formal education and the benefits that can be derived from mixing learning with playtime, it is well known that a child's toy can provide a significant benefit to the intellectual development of the child.

Unfortunately, the prior art educational toys that have been devoted to providing instruction to children have been limited in the material that they could teach. In many cases, these prior art toys utilize either a digital memory or tape media as a source of program information. The instructional material in those prior art toys which utilize digital memory is usually pre-programmed into the toy and cannot be changed by the user. Where the instructional material can be changed, it is usually through the use of magnetic media in the form of cassette tapes.

In operation, the instructional material is changed by simply swapping out one cassette tape for another. The manufacturers of these toys usually offer many different cassette tapes to augment the instructional value of the toy and to increase the play value to the child. However, the extra burden associated with maintaining control of the tapes and keeping them in an operational state effectively limits their long-term value to the user. While the above-noted devices are highly effective for their intended purpose, the long term instructional value of the currently available toys is diminished by the limited ability (tape), or complete inability (conventional ROM or EPROM based digital memory) to routinely change the instructional lessons provided by the toy.

Other prior art educational toys are electronic toys that have a reprogrammable, or re-recordable, data storage device, such as a recordable tape media, or digital memory. With these devices a user can selectively load new program information into the reprogrammable data storage device from an external data source to change the operating characteristics of the toy. As a result, a reprogrammed toy may generate totally different outputs in response to inputs. In this regard, not only may a toy's sounds be new, but its entire behavior and associated play pattern may be replaced. The new program information may be downloaded into the toy from a data source such as a personal computer, CD-ROM, etc. A data input line may be releasably connected between an output port of the data source and an input port of the toy to download new program information. Such a device is described in U.S. Pat. No. 6,012,961 to Sharpe, et al.

Although capable of providing a significant broader range of educational material, than with digital memory or data tapes, these types of electronic toys may still provide a less than complete interactive, progressive learning experience for the user. Specifically, the prior art devices are incapable of evaluating user inputs and tracking a child's progress toward learning the material. In essence, these devices can regurgitate information, but they cannot interact with the child to assess the user's strengths and weaknesses. In addition, such devices are not capable of reporting progress and modifying the instructional program in response to progress. Further, none of the prior art toys disclose a device that co-mingles instructional lessons with games, songs and stories to provide a toy which capably functions as an instructional device, a toy, or both. Moreover, the prior art devices fail to address other areas of development in children such as social skills, personality traits and other personal and personality related areas.

There is thus a perceived need for an improved device that functions both as a toy and a developmental tool for children, which is capable of being customized with easily modifiable and/or replaceable program content to aid in the overall development of a child. There is also a need for a combination instructional device and entertainment device that is capable of dynamic interaction with the child while capturing the child's development through interaction with the device. Finally, there is a need for a combination instructional device and entertainment device that fully integrates instructional material with entertainment-related material to create a welcome diversion for the child and further enhance the developmental experience.

### SUMMARY OF THE INVENTION

Apparatus, methods, and articles of manufacture consistent with the present invention provide a development system that includes an intelligent companion (IC) computer and a central computer. The IC computer may create new experiences for a user by dynamically interacting with the user to provide companionship, educational and overall developmental experiences. The interactive behavior of the IC computer may be customized to the needs and/or desires of the user. Customization of the IC computer may involve communication with the central computer.

Interactive behavior of the IC computer may be based on operational and/or instructional program content stored therein. Program information may be selectively transferred to the IC computer to customize the interactive behavior. Transfer of the program information may be from an external data source such as the central computer. The program information may modify the program content stored within the IC computer.

Interaction between a user and the IC computer may also be captured with the IC computer. The user's interaction and the corresponding interactive behavior of the IC computer may be captured and transferred to the central computer as interaction data. The central computer may analyze the user interaction in conjunction with the corresponding interactive behavior of the IC computer to ascertain the development of the user. Based on this analysis, modifications to the operational and instructional program content may be transferred to customize the interactive behavior of the IC computer and enhance the development of the user. In addition, the central computer may tabulate the interaction data into developmental results that may include educational testing results, cognitive learning results, personality trait assessments, social skill assessments, etc. The results may be accessed at the central computer to gain understanding not only of the educational level but also the social, interpersonal, comprehension and cognitive skill levels of the user.

An interesting feature of the development system involves generation of the program information to modify the interactive behavior of the IC computer. Within the central computer, program information criteria may be developed by an administrator of the user's development such as a parent, the user, a guardian, etc. The program information criteria may provide criteria for generation of the program information, such as the specification of certain areas for development, languages, etc.

Another interesting feature of the development system involves modification and approval of the program information prior to transfer to the IC computer. The program information generated automatically by the central computer may be modified by an administrator of the user's development prior to transfer. Modification may involve eliminating material, modifying material and adding additional material to customize the interactive behavior of the IC computer. In addition, the administrator may approve the transfer of the program information. Modification by the administrator may be based on review of the developmental results generated from the interaction data.

Additional objects and advantages of the invention will be set forth in part in the description which follows, and in part will be clear from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and, together with the description, serve to explain the principles of the invention.

FIG. 1 is a block diagram of an exemplary development system.

FIG. 2 is a more detailed block diagram of a user workstation within the development system of FIG. 1.

FIG. 3 is a more detailed block diagram of an intelligent companion (IC) computer within the development system of FIG. 1.

FIG. 4 is a more detailed block diagram of a remote server within the development system of FIG. 1.

FIG. 5 is an exemplary flow diagram illustrating the cooperative operation of a user workstation and a remote server within the development system of FIG. 1.

FIG. 6 is a second part of the flow diagram of FIG. 5.

FIG. 7 is an exemplary flow diagram illustrating the cooperative operation of an intelligent companion computer.

### DESCRIPTION OF THE PREFERRED EMBODIMENTS

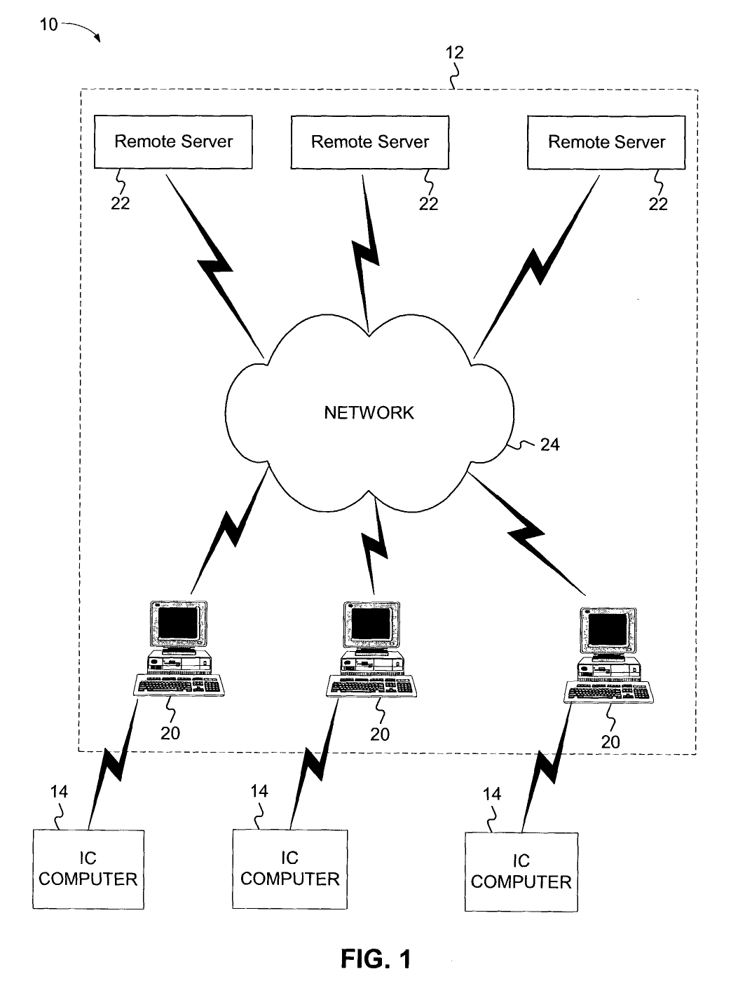

FIG. 1 is a block diagram of an exemplary development system 10. The development system 10 includes a central computer 12 in selective bi-directional communication with at least one Intelligent Companion (IC) computer 14. The central computer 12 may be one or more computing devices capable of executing instructions and bi-directionally communicating with the IC computer 14. Bi-directional communication between the central computer 12 and the IC computer 14 may be wireline communication via a cable or other similar communication path, or may be wireless via radio waves, infrared (IR) or any other wireless communication path.

The illustrated central computer 12 includes at least one user workstation 20 interfacing with a corresponding IC computer 14. In addition, the central computer 12 includes at least one remote server 22 interfacing with the user workstations 20 over a network 24. The user workstations 20 may be generally similar to the remote servers 22 and include well-known devices such as central processing units, display devices, network interface devices and user interfaces. The user workstations 20 may also perform operations described herein as being performed by remote servers 22. Similarly, remote servers 22 may perform operations described herein as being performed by user workstations 20.

The network 24 may be a distributed system that may include any of a number of types of networks over which client computers and server computers communicate, including local area networks (LANs), wide area networks (WANs), the Internet and any other networks capable of distributed processing and data sharing among a plurality of nodes. Communication over the network 24 may include wireless communication and/or wireline communication. The communication medium may be for example, a communication channel, radio waves, microwave, wire transmissions, fiber optic transmissions, or any other communication medium capable of transmitting data, audio and/or video.

During operation, the user workstation 20 may receive program information from a remote server 22. Program information may include modifications to program content within the IC computer 14. Program content within the IC computer 14 may include games, songs, poetry, conversational interaction, test data, mannerisms, languages and/or any other program data and/or audio files used to create interactive behavior of the IC computer 14.

The user workstations 20 may allow review, modification and selective transfer of the program information to an associated IC computer 14. Modification of the program information may include requesting additional program information from the remote server 22 (or any other information source), deleting program information and/or modifying program information. In addition, modification may include customizing program information, such as adding the name of the user, a telephone number and home address of the user, names of family members or any other information may be added to personalize and customize the program information to the particular user(s). For example program information which tests the user for an understanding of their family members could be customized to indicate the “brother”=“Bruce”, “Aunt”=“Allison”, etc. Transfer of the program information to the IC computer 14 may be selectively enabled with the user workstations 20.

Interaction data from a corresponding IC computer 14 may also be received by the IC computer 14. The interaction data may be transferred to a remote server 22 by the user workstations 20 for analysis and processing. The term “interaction data” should be broadly construed to include any information relating to communication, contact, interface, dealings and/or relationship between a user and the IC computer 14. The interaction data may include data representative of inputs (or lack of inputs) by the user as well as data representative of the corresponding outputs and/or other interactive behavior of the IC computer 14. The interaction data may include educational testing results, cognitive learning results, personality trait data, social skills data, etc. based on the dynamic interaction between the user and the IC computer 14.

Utilizing the user workstation 20, developmental results such as reports and other information generated by the remote server 22 may be accessed and analyzed. In addition, program information criteria that includes logical rules for the generation of program information as well as any other configuration related data may be created, accessed and/or manipulated with the user workstation 20. Further, additional information, such as comments, etc. may be added to the reports and other archived data stored at the remote servers 22 with the user workstation 20. The user's private information as well as public information such as internet links, behavioral studies, articles, etc. may be stored.

Access to perform analysis and modification may be performed with the user workstation 20 by an administrator. The administrator may be any individual or group of individuals involved with the user's development such as, for example, a teacher, the user, a parent, a guardian, a health professional or any other individual(s) involved with the user's growth and development.

The remote servers 22 may access and/or maintain a cache of entertainment/instructional material for transfer to an IC computer 14. In addition, the remote servers 22 may analyze interaction data received from the user workstations 20. Based on analysis of the interaction data, the remote servers 22 may create developmental results such as reports and other user development related data. Within the developmental results, the remote servers 22 may also maintain an archive of data related to the interaction between the user and the IC computer 14. The archive may provide long term trends and other useful information relating to the development of the user. The remote servers 22 may also generate program information for subsequent transfer to the IC computer 14 based on the interaction data and the program information criteria.

A user account related to each user of an IC computer 14 within the development system 10 may also be maintained by the remote servers 22 and/or the user workstations 20. The user accounts may include personalized individual information, as well as public information related to each user. Information within the user account may include the identity of the user and the corresponding IC computer 14, passwords, program information criteria, reports, comments, archived interaction data and any other information related to the activity of the user within the development system 10. The user account may be maintained with security such that only authorized individuals such as the administrator are provided access.

The IC computer 14 may be any electronic device, such as an electronic toy, capable of interactive behavior with a user that may also selectively communicate with the user workstations 20 and/or the remote servers 22. During operation, the IC computer 14 may receive program information from a user workstation 20 or a remote server 22. The program information may revise the program content within the IC computer 14 to customize the interactive behavior of the IC computer 14. The IC computer 14 may selectively execute the program information as a part of the program content during subsequent interaction with a user. When the interactive behavior of the IC computer 14 elicits and/or receives input(s) representative of interaction by the user, the IC computer 14 may store and transfer interaction data to user workstation 20 and/or remote server 22 for analysis. The interaction data may be representative of the interaction by the user with the IC computer 14 and the corresponding interactive behavior of the IC computer 14 with the user.

Transfer of interaction data may be between the IC computer 14 and the user workstation 20 and/or the remote server 22. For example, the user workstation 20 may operate as a data translator between the IC computer 14 and the remote server 20. Alternatively, the remote server 22 may communicate directly with the IC computer 14 using communication hardware of the user workstation 20. The remote server 22 may also communicate directly with the IC computer 14 using communication hardware of the remote server 22.

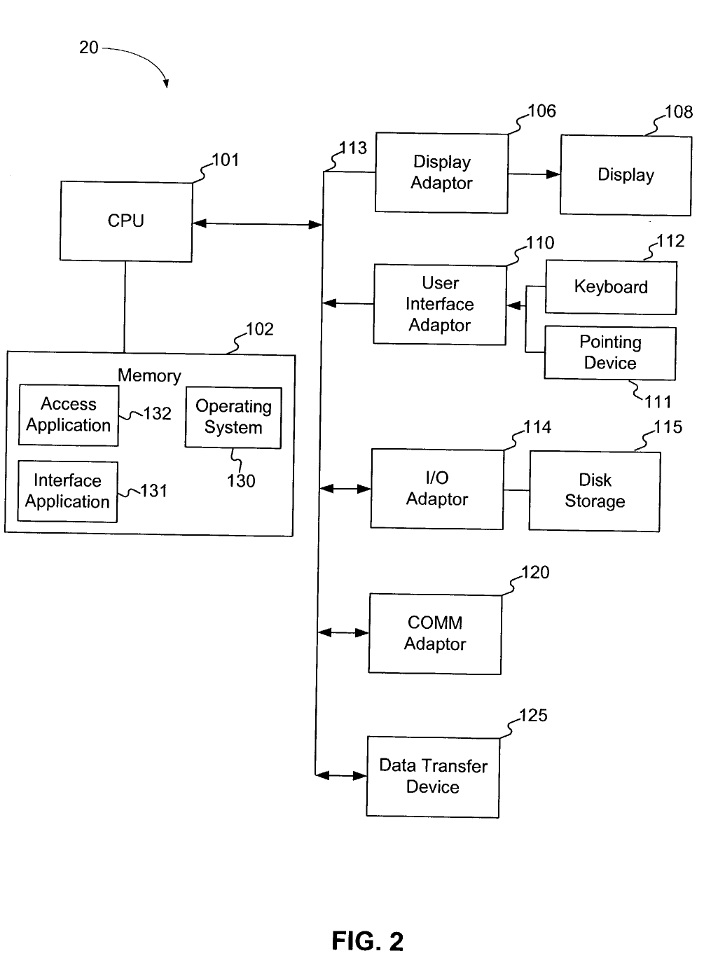

FIG. 2 is a more detailed block diagram of an exemplary user workstation 20. The illustrated user workstation 20 includes a central processor unit (CPU) 101, a memory 102, a display adapter 106, a display 108, a user interface (UI) adapter 110, a pointing device 111, a keyboard 112, an input/output (IO) adapter 114 and a disk storage unit 115. In addition, the user workstation 20 includes a communications adapter 120 for providing a communication function to the network 24 (FIG. 1), and a data transfer device 125 for providing a communication function with the IC computer 14 (FIG. 1).

Memory 102 may be any form or memory device such as a read only memory (ROM) that includes instructions capable of execution by the CPU 101. The illustrated memory 102 includes instructions within an operating system 130 for operating the device and an access application 132 for accessing and displaying content from devices on the network 24, such as the remote servers 22. In addition, the memory 102 may include instructions within an interface application 131 for receiving, analyzing and/or modifying data from access application 132 and receiving, analyzing and/or transferring interaction data from IC computer 14. The interface application 131 may also be utilized to receive, analyze, edit and/or control transfer of program information. Further, the interface application 131 may include capability to translate interaction data and/or program information to protocols, formats, etc. compatible with the recipient of such information prior to transfer.

As shown, the various components of each user workstation 20 communicate through a system bus 113 or other similar communication path. The hardware arrangement of the user workstation 20, as well as other computing devices discussed in this specification are intentionally shown generally, and are meant to represent a broad variety of architectures, which depend on the particular computing device used.

As further shown in FIG. 2, display adaptor 106 is coupled to display 108. In addition, user interface adaptor 110 is coupled to pointing device 111, such as a mouse and keyboard 112. I/O adaptor 114 is coupled to disk storage unit 115. Disk storage unit 115 may be any form of read/write data storage device such as a hard drive, optical disc, etc. Communications adaptor 120 is capable of providing wireline and/or wireless communication between the user workstation 20 and the network 24 (FIG. 1). Similarly, data transfer device 125 may provide wireline and/or wireless communication between the user workstation 20 and the IC computer 14 (FIG. 1).

During operation, the user workstation 20 may selectively communicate with the IC computer 14 and/or the remote servers 22. The user workstation 20 may operate as an access point for access to the remote servers 22. Access to the remote servers 22 over the network 24 may be, for example, with a browser operating on the user workstation 20 with the access application 132. In addition, where the analysis and program information generation occurs at the remote servers 22, the user workstation 20 may access and pass information between the IC computer 14 and the remote server 22.

The user workstation 20 may be used by the administrator to actively manage and store information transferred to and from the IC computer 14. The remote servers 22 may, for example, transfer program information to the user workstation 20 for storage in disk storage 115. Alternatively, program information in disk storage 315 of the remote servers 20 may be accessed by the user workstations 20. The transfer of program information to the IC computer 14 may be monitored and controlled with the user workstation 20. In addition, within the user workstation 20, the administrator may modify the program information by, for example, requesting additional program information from the remote servers 22, deleting program information, etc. Further, developmental results such as interaction data, reports and other archived materials resulting from the analysis of the interaction data by the remote servers 22 may be stored, accessed and edited by the administrator with the user workstation 20

An administrator may employ keyboard 112 and pointing device 111 of user workstation 20 to control the selection of various program information to be transferred to IC computer 14. For example, an administrator may wish to select a variety of audible programs that may be converted into corresponding encoded data by user workstation 20. Once approved by the administrator, the encoded data may be output as program information to the corresponding IC computer 14.

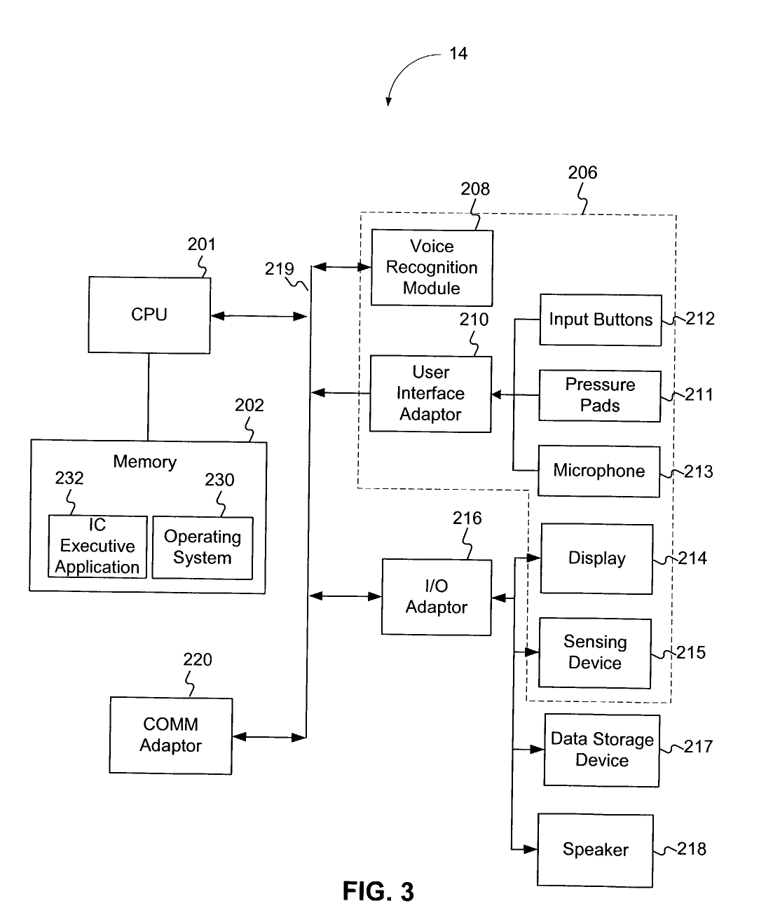

FIG. 3 is a more detailed block diagram of an exemplary IC computer 14. As with user workstations 20, illustrated IC computer 14 includes a CPU 201 and a memory 202 that may be any memory device such as a ROM memory. In addition, the IC computer 14 includes at least one user input 206. The illustrated user inputs 206 include a voice recognition module 208, a UI adapter 210, pressure pads 211, input buttons 212, a microphone 213, a display 214 and a sensing device 215.

The illustrated IC computer 14 also includes IO adapter 216, data storage device 217 and speaker 218. IO adaptor 216 may provide connectivity and data translation for data storage device 217, speaker 218, display 214 and sensing device 215. Further, similar to user workstation 20, the illustrated IC computer 14 includes communications adapter 220 for providing connectivity between IC computer 14 and user workstation 20 and/or remote server 22. As in the user workstation 20 (FIG. 2), the components of each IC computer 14 communicate through a system bus 219 or similar architecture.

Memory 202 includes an operating system 230, and an Intelligent Companion (IC) executive application 232 selectively accessed by CPU 201. The operating system 230 may provide instructions forming the operating system of IC computer 14. The IC executive application 232 may include instructions for communicating with an external user workstation 20, remote servers 22 and/or any other device. In addition, the CPU 201 may utilize the IC executive application 232 and the operating system 230 in cooperative operation to selectively execute specific code included in the program content stored in data storage device 217.

Data storage device 217 is coupled to I/O adaptor 216 and includes reprogrammable solid state memory such as flash memory, EEPROM, and/or battery backed random access memory (RAM). The program content stored in data storage device 217 may be utilized by the operating system 230 and the IC executive application 232 to create customized interactive behavior of IC computer 14. Data storage device 217 may also provide additional storage space (such as RAM storage) for storing interaction data prior to transmission of the interaction data to the user workstation 20 or remote servers 22. Data storage device 217 may further store an identifier code, which uniquely identifies the user and/or IC computer 14.

During operation, the user may input interaction data in the form of a response, a series of responses and/or a lack of response to the data storage device 217 via the user inputs 206. Data representative of the corresponding interactive behavior of the IC computer 14, such as program content or interactive outputs of the IC computer 14 may also be input as interaction data to the data storage device 217. When the IC computer 14 is enabled to communicate with the user workstation 20 or the remote servers 22, interaction data representative of the interaction between the user and the IC computer 14 may be transmitted.

The interaction data may include a user input(s) representing a response(s). In addition, program content and/or a corresponding output(s) of the IC computer 14 representative of interactive behavior of the IC computer 14 may be included in the interaction data. Alternatively, a code(s) identifying the response(s) and/or corresponding output(s) (program content) may be included in the interaction data. In addition, the interaction data may include an identifier code, so that the remote server 22 may associate the interaction data to the particular user (or to the IC computer 14, which, in turn, is assigned to the user), and thereby distinguish interaction data provided from different users.

User inputs 206 to the IC computer 14 may include any mechanism or device for enabling a user to input information or to otherwise control IC computer 14. Exemplary user inputs 206 that include pressure pads 211, input buttons 212 and/or microphone 213 may be coupled to bus 219 via user interface adaptor 210. Additional exemplary user inputs 206 that include display 214 and sensing device 215 may similarly be coupled to bus 219 via I/O adaptor 216.

Display 214 may be a liquid crystal display (LCD), plasma display or any other form of graphical user interface (GUI). A user may input information into display 214 by any form of input device such as a touch-screen, light pen, stylus or any other arrangement whereby a user may, for example, select one or more entries displayed on the screen. The user may, by means of a light pen or stylus, register a written (textual) response in, for example, essay form, by drawing the light pen or stylus over the display screen to effect printed or written textual characters or graphical indicia.

Sensing device 215 may be any device, such as a pad, capable of detecting contact by a user. During operation, sensing device 215 may respond to inputs from the user such as a light pen or stylus that may be drawn over the sensing device 215. Sensing device 215 may be utilized in conjunction with the display 214. For example, the user may draw the light pen or stylus over sensing device 215, and the IC computer 14 may display the drawn characters or graphical indicia with display 214.

Interactive outputs directed to the user from the IC computer 14 may be provided as part of the interactive behavior of the IC computer 14. The interactive outputs may include visual and/or audio outputs. Audio outputs may be provided by the speaker 218 or any other device capable of audible outputs. Visual outputs may include indications on the display screen 214, indicator lights, mechanical movement or any other visually related interactive behavior that may be supported by the CPU 201.

The CPU 201 may also utilize IC executive application 232 to selectively transfer program information into data storage device 217 via communications adaptor 220. As previously discussed, the program information may modify the stand-alone operating characteristics, i.e. interactive behavior and play pattern, of the IC computer 14. Program information, may be transferred to the IC computer 14 in many ways not intended to be limited by the present description herein. However, the illustrated data transfer system includes communications adaptor 220 connected to bus 219 of IC computer 14 and data transfer device 125 in user workstation 20 and/or data transfer device 325 in remote servers 22.

When the communications adaptor 220 is in communication with user workstation 20, user workstation 20 may receive information from, and transmit information to the data storage device 217 in IC computer 14. Program information may be received by communication adaptor 220 and converted to appropriate data signals which are supplied to CPU 201. CPU 201 may utilize IC executive application 232 to further configure the received program information to modify the program content stored within data storage device 217.

IC computer 14 may be included in any object capable of being handled by a user. If for example, the user is a young child, IC computer 14 may be encased inside of a toy or doll. The toy may be a doll or stuffed animal having a speaker (output device 218) for audio output, and a plurality of input buttons 212 and pressure pads 211 which, when pressed, cause CPU 201 to retrieve various program content stored in data storage device 217. In addition, CPU 14 may receive and respond to audio inputs provided by the user with microphone 213 and voice recognition module 208. Further, CPU 201 may selectively direct the operation of various audio and/or visual outputs and animation such as physical movement of the toy using servos and other motorized devices to generate sounds coordinated with gestures based on the program content and the various user inputs 206. Additional output devices could also include lamps or other devices that are activated either singly or in various combinations in response to the specific input scenarios as specified by the program content stored in data storage device 217. CPU 201 may also utilize IC executive application 232 to write interaction data into data storage device 217.

Alternatively, IC computer 14 may resemble a portable handheld electronic device, such as a Palm Pilot™, Visor™, personal digital assistant (PDA), etc. for older users. The handheld device may similarly include various user inputs and device outputs adapted for the capabilities of the handheld device such as a touch screen display 214 and/or sensing device 215

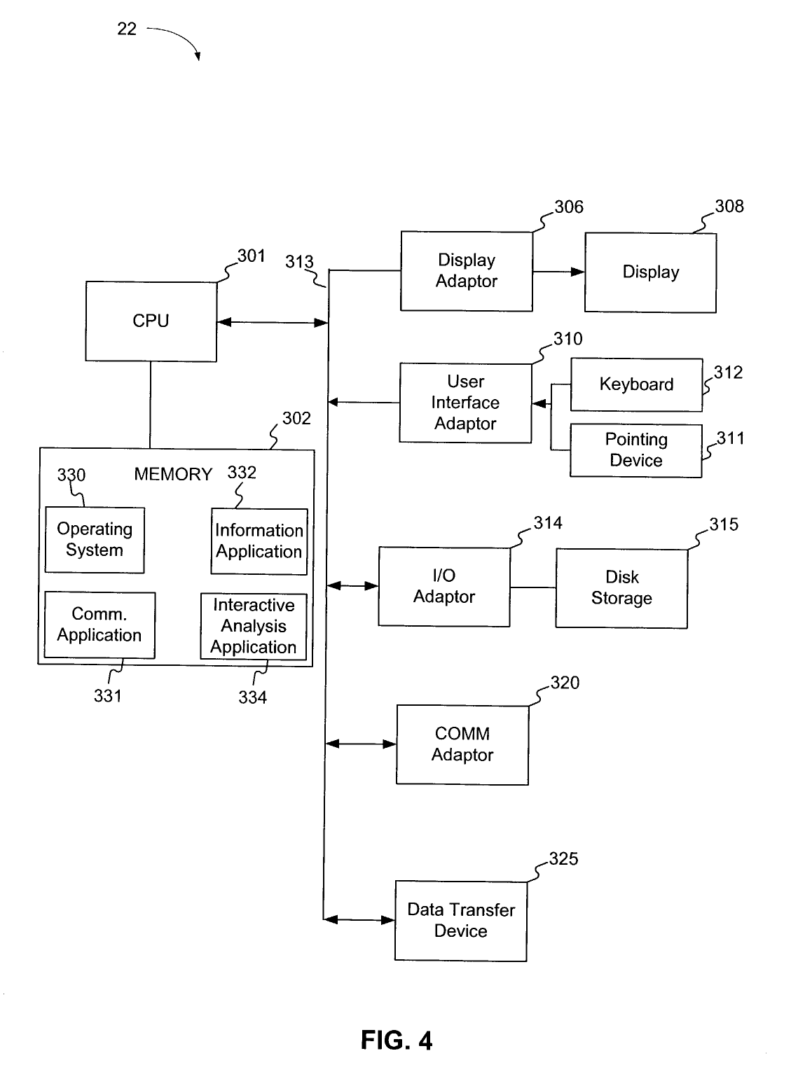

FIG. 4 is a block diagram of an exemplary remote server 22. Similar to the user workstation 20, the illustrated remote server 22 includes a CPU 301, a memory 302, a display adapter 306, a display 308, a UI adapter 310, a pointing device 311, a keyboard 312, an IO adapter 314 and a disk storage unit 315. In addition, the remote server 22 includes a communications adapter 320 for providing a communication function over the network 24 (FIG. 1). Further, the remote server 22 may also include a data transfer device 325 for interfacing with IC computer 14.

Memory 302 may be any form of memory device. Stored in memory 302 may be instructions within an operating system 330, a communication application 331, an information application 332 and an interactive analysis application 334. The operating system 330 may include instructions to control the overall operation of the remote server 22 in a well-known manner. The communication application 331 may include instructions to provide a communication interface with IC computers 14 and user workstations 20. An exemplary interface with the user workstations 20 may involve a webserver application serving information to a browser in the user workstations 20 in a well-known manner. In addition, the communication application 331 may also store interaction data transferred from the IC computers 14. The interaction data may be stored separately for each user within disk storage 315 based on the identity of the user and/or the identity of the IC computer 14

Information application 332 may include instructions to allow access to the cache of entertainment/instructional material stored in disk storage 315. In addition, information obtained via the Internet, other servers or any other source of data may be accessed with instructions in the information application 332. Further, instructions in the information application 332 may allow access and manipulation of user accounts, interaction data, archives, reports and any other materials within the remote servers 22 by the user workstations 20. Storage of comments and other information in conjunction with the interaction data, reports and other materials may also be supported by the instructions of the information application 332. Further, security for the data within the remote server 22, such as user ids and passwords may be managed by instructions in the information application 332.

The interactive analysis application 334 may include instructions to perform individual analysis of the interaction data that includes user inputs (or lack of user inputs) and the corresponding interactive behavior of the IC computers 14. The analysis may be performed to ascertain the developmental results of the user. The analysis may also include comparison with past interaction data of the user. In addition, comparison of results of an individual user with a population of similar users may also be performed. For example, the user may be identified as scoring in the 98^{th} percentile of other users in the same age group on a particular educational/instructive lesson.

As a result of the analysis, program information may be developed by the instructions in the interactive analysis application 334 for individual IC computers 14. For example, development of the program information may involve review of the user's previous interaction data in related subject areas to generate program information that emphasizes those areas where the user needs more work, while de-emphasizing those areas where the user shows strength. Similarly, the interactive analysis application 334 may include instructions to review previously transferred program information related to entertainment for example and generate program information that provides a subsequent version of the material (e.g., next chapter in a story currently being told) or entirely new material (new games, songs, stories, etc.)

Program information may be developed by the interactive analysis application 334 based on program information criteria related to enhancing the development of the user. The program information criteria may be defined within the user account by an administrator such as the user, a parent or guardian. For example, program information criteria may be selected to emphasis the development of compassion for others, sharing, leadership, assertiveness, etc. Similarly, program information criteria may be selected to emphasis eye-hand coordination, formal education such as math, spelling etc., poetry, foreign languages and/or any other area where development of the user is desirable. Program information for each IC computer 14 may be generated by the cooperative operation of the information program 332 and the interactive analysis application 334.

The interactive analysis application 334 may also include instructions to tabulate and maintain developmental results. The developmental results may include the ongoing receipt of interaction data, program information criteria selected by the administrator, program information generated by the remote server 22, modifications to program information by the administrator and any other development related information of the user. Tabulation may include generation of developmental reports in the form of test scores, behavioral trends, favorite activities, attention span, etc. Maintenance may include archiving the information such that long term trends as well as past development may be analyzed. Accordingly, developmental results may be accessed to gain understanding not only of the educational level but also the social, interpersonal, comprehension and cognitive skill levels of the user.

An exemplary report may include cumulated correct and incorrect responses to educational lessons, attention span analysis during different dynamic interactions, social skills analysis during different dynamic interactions, frequency of repetition of the same dynamic interaction (such as songs, games, etc.) and/or any other information which may be useful to analysis of the development of the user.

Referring now to FIGS. 1-4, in general, IC computer 14 may operate in a data transfer mode and a stand-alone mode. In the data transfer mode, IC computer 14 may be coupled to data transfer device 125 (or 325) and information may be bi-directionally communicated between a user workstation 20 (or remote server 22) and data storage device 217 of IC computer 14. In operation, IC computer 14 may be positioned in appropriate proximity to data transfer device 125 (or 325) to establish a communication link between communications adaptor 220 and data transfer device 125 (325). For example, where an infrared communication link is utilized, IC computer 14 may be physically aligned with respect to data transfer device 125 (or 325) to allow data transfer device 125 to direct an infrared beam incident upon communication adaptor 220.

Once IC computer 14 is properly positioned within, or with respect to, data transfer device 125 (325), the bi-directional flow of information may occur. Following transfer of program information and interaction data, communication between IC computer 14 and data transfer device 125 (325) may be terminated. Accordingly, IC computer 14 may process the program content within the data storage device 217 in complete independence of user workstation 20 and/or remote server 22. Upon completion of the data transfer, IC computer 14 may be removed from proximity with data transfer device 125 (325).

IC computer 14 may also be operated in data transfer mode to interactively communicate with user workstation 20 (or remote server 22) in real time. Since the interface formed between data transfer device 125 (325) and communications adaptor 220 is a two-way data interface, user workstation 20 may send commands through data transfer device 125 to communications adaptor 220 and receive user inputs from IC computer 14 through the same interface. For example, while coupled to the data transfer device 125, IC computer 14 may receive commands from the associated user workstation 20, execute the commands, and then send data back to the user workstation 20 that, for example, a certain user input 206 was activated, e.g., a certain input button 212 was depressed.

In stand-alone mode, IC computer 14 may access data storage device 217 to execute the program content and store interaction data representative of interaction between the user and IC computer 14. In addition, since the development system 10 may be deployed within a distributed system environment, during standalone mode, the remainder of development system 10 may also independently operate. As previously discussed, independent system operation may include communication over the network 24 via internal, external and intranet networks as well as the Internet to connect user workstations 20 to remote servers 22, such as World Wide Web servers, personal network servers, etc.

The remote servers 22 may cooperatively operate to support operation of the development system 10. One of the remote servers 22 may act as an agent for one of the user workstations 20. In an agent capacity, the remote server 22 may provide a gateway function for the user workstation 20. For example, the remote server 22 may gather data from one or more other remote servers 22 coupled to the network 24 and provide that data as program information to the user workstation 20 and eventually to IC computer 14. In another example, user workstation 20 may initiate a request(s) to a first remote server 22 for access to a Web site located on second remote server 22. The agent function may be designated to a particular remote server 22 for each user workstation 20, or may be based on establishing communication with a user workstation 20.

Alternatively, user workstation 20 may access all of the remote servers 22 depending on the operations being performed. In this case, user workstation 20 may selectively communicate with multiple remote servers 22 to access user information and program information. For example, one remote server 22 may be accessed to obtain archived developmental information on a user, a second remote server 22 may be accessed to obtain program information and a third remote server 22 may be accessed to set up program information criteria for generation of program information.

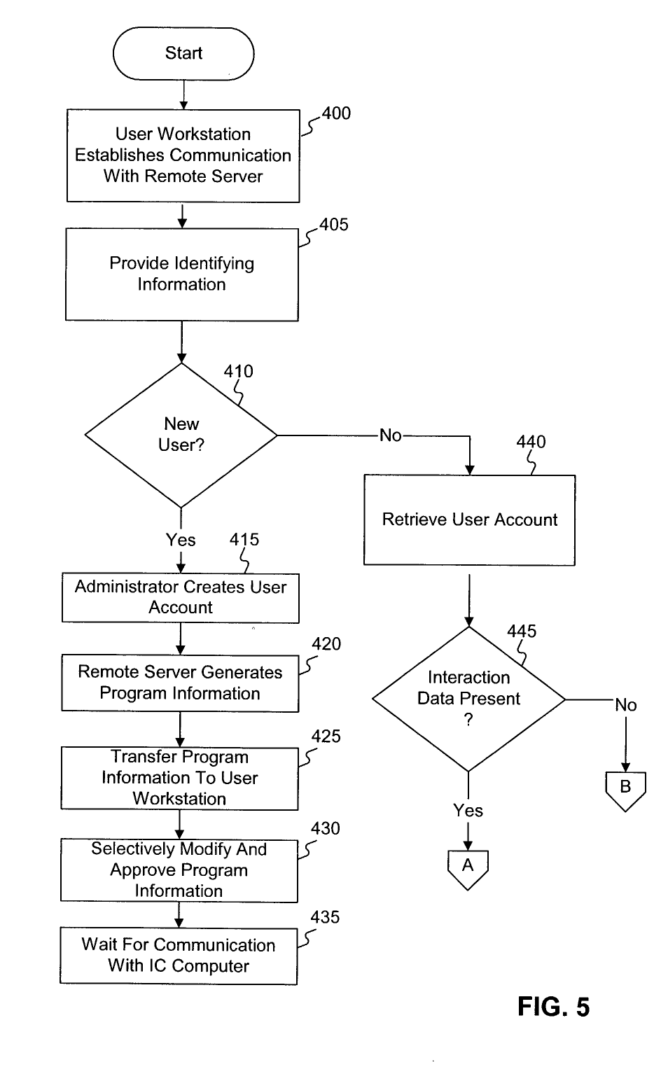

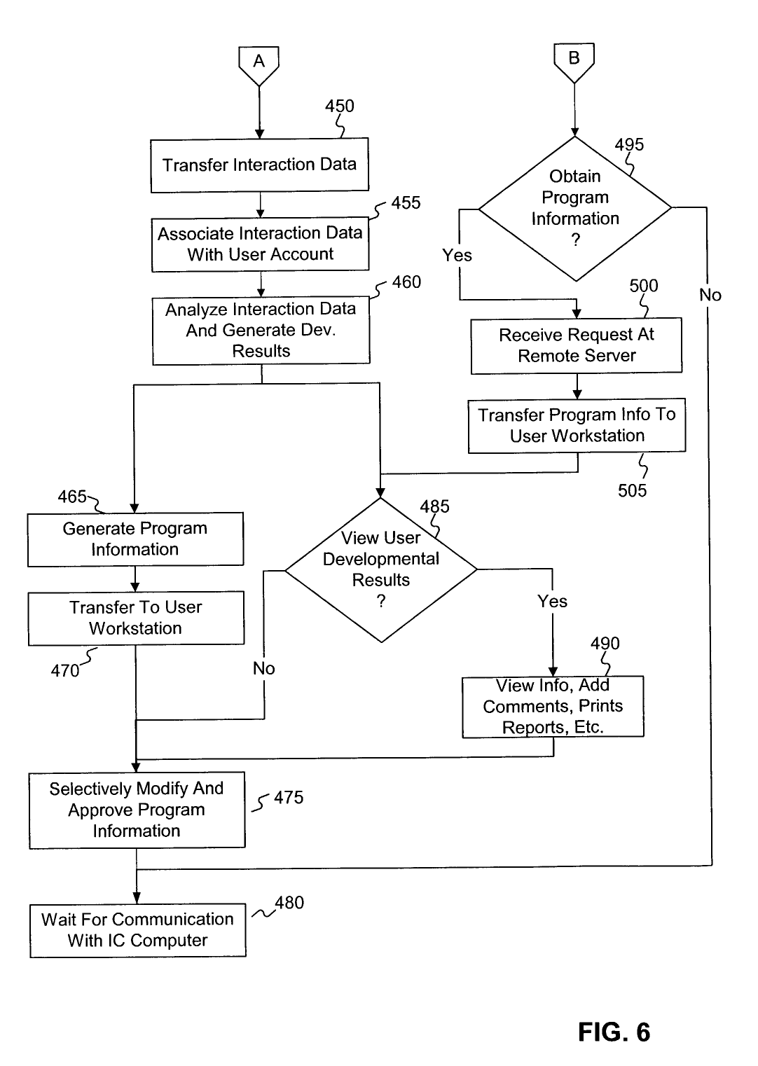

FIGS. 5 and 6 are a flow diagram illustrating exemplary cooperative operation of user work station 20 and remote servers 22 with reference to FIGS. 1-4. In this example, the remote server 22 is generally discussed as a single device however; remote server 22 may actually include multiple independent remote servers 22 communicatively coupled in a distributed architecture as illustrated in FIG. 1. Accordingly, the various functions of remote server 22 may actually be distributed among multiple remote servers as previously discussed. In addition, as previously discussed, operations performed by the remote servers 22 may be performed with the user work stations 20 and vice-versa.

As shown in FIG. 5, an administrator operating user workstation 20 establishes communication with the remote server 22 via the network 24 at block 400. For example, the administrator operating user workstation 20 may invoke a menu item displayed by the interface application 131 to establish communication. The communication may be in the form of a browser from the access application 132 in the user workstation 20 being served by a webserver within the communication application 331 of the remote server 22. At block 405, the administrator operating the user workstation 20 is requested to provide identifying information, such as a user name and password.

Communication application 331 determines whether the user is logging into the developmental system 10 for the first time at block 410. If the administrator is new, at block 415 the administrator is prompted to create a user account. Creation of the user account may include providing background information on the user of IC computer 14, identifying the user and IC computer 14, establishing the unique identity of the user and/or the IC computer 14, providing program information, criteria, etc.

Based on the information provided in the user account, the interactive analysis application 334 and information application 332 may generate program information for the identified user and IC computer 14 at block 420. At block 425, the program information may be transferred to the user workstation 20 over the network 24 with communication application 331. The administrator may receive and selectively modify the program information at block 430 using interface application 131. Modification of the program information may include requesting additional program information from the remote server 22, deleting program information, customizing program information and/or modifying program information. At block 435, following modification and approval by the administrator, the user workstation 20 awaits communication with the identified IC computer 14 to transfer the program information.

If at block 410 the communication application 331 identifies the administrator as an existing user, the user account associated with the logged on administrator is located and retrieved at block 440. Once the user account information is retrieved, the communication application 331 of remote server 22 determines if the user workstation 20 includes new interaction data transferred from a corresponding IC computer 14 at block 445.

Referring now to FIG. 6, if new interaction data is present, the interaction data is transferred from disk storage 115 to disk storage 315 at block 450. At block 455, the interaction data is associated with the retrieved user account by the communication application 331. Interactive analysis application 334 analyzes the interaction data in conjunction with existing interaction data and generates developmental results that are associated with the user account at block 460. At block 465, the interactive analysis application 334 and the information application 332 cooperatively operate to generate program information based on the analysis and the program information criteria. The program information is transferred to the user workstation 20 at block 470. At block 475, the administrator is prompted to selectively modify the program information. After modification and approval of the program information by the administrator, the interface application 131 awaits communication with the IC computer 14 to transfer the program information at block 480

Following analysis of the interaction data at block 460, the administrator is also prompted to view the developmental results through dynamic data analysis, reports etc. at block 485. If the administrator chooses to view the developmental results, the user may view the information, add comments, print reports, etc. at block 490 using access application 132. When the administrator completes viewing, the operation may proceed to block 475 where the administrator may selectively modify the program information as previously discussed. Similarly, where the administrator elects not to view the user developmental results at block 485, the operation may proceed to block 480 to await communication with the IC computer 14.

Referring again to FIG. 5, if there is no new interaction data present in the user workstation 20 at block 445, the administrator is prompted to manually request program information from the remote server 22 at block 495 of FIG. 6. Referring still to FIG. 6, if the administrator elects to make a manual request, the communication application 331 receives the request at block 500. At block 505, corresponding program information is generated with interactive analysis application 334 and information application 332 and transferred to the user workstation 20 by the communication application 331. The operation then proceeds to block 485 where developmental results may be viewed and the program information may be selectively modified by the administrator as previously discussed. If the administrator elects not to manually request program information at block 495, the operation proceeds to block 480 to await communication with the IC computer 14.

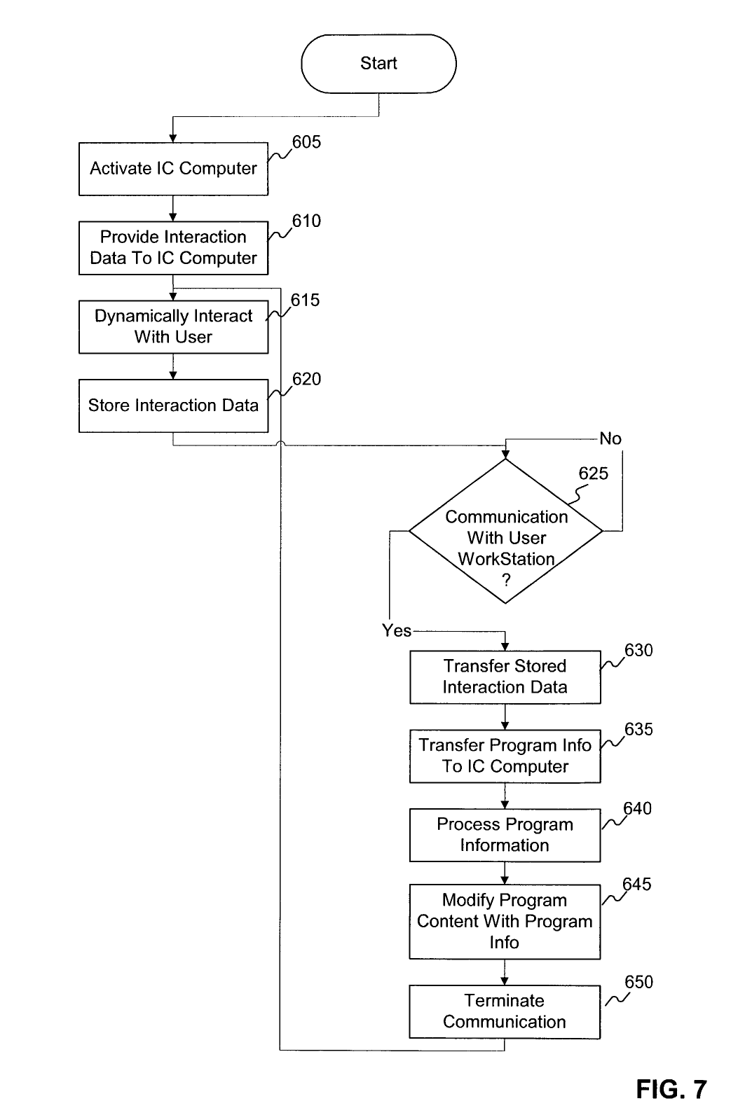

FIG. 7 is a flow diagram of exemplary operation of the IC computer 14 illustrated in FIG. 3 following transfer of program information to the IC computer 14 from user workstation 20 or remote servers 22. At block 605, operation of operating system 230 begins when the user activates the IC computer 14. At block 610, the user provides interaction data through a user input 206 such as, voice commands provided to microphone 213 to instruct IC computer 14 to play a game, sing a song, read a story, etc. Alternatively, the user could interact with IC computer 14 through a user input 206 such as, in the case of a stuffed toy, pressure pads 211 (e.g., “Squeeze may left hand to play a game”, “Squeeze my right hand to sing a song”, “Squeeze my left foot if you would like me to read you a story”, etc.)

The IC executive application 232 may selectively access the program content in the data storage device 217 to dynamically interact with the user at block 615. At block 620, inputs from the user and the corresponding interactive behavior of the IC computer 14 are stored as interaction data in the data storage device 217. Block 610 and 612 may then be repeated.

Communication adaptor 220 monitors for communication with the user workstation 20 or remote server 22 at block 625. If communication is not established, communication adaptor 220 continues monitoring. If communication is established, IC executive application 232 transfers the stored interaction data to the user workstation 20 or remote server 22 via the communication adaptor 220 at block 630. At block 635, program information is transferred to the IC computer 14 from the user workstation 20 or the remote server 22. The IC executive application 232 processes the program information at block 640. At block 645, the program content within the data storage device 217 is modified with the program information.

Communication with the user workstation 20 may be terminated at block 650. The operation then returns to block 615 where the IC computer 14 may utilize the modified program content to dynamically interact with the user. When the user is no longer interacting with the IC computer 14, or when additional program information is desired, the IC computer 14 may again be positioned to establish communication with the user workstation 20 and the operation returns to block 625.

Alternatively, the IC computer 14 may instruct the user to place the IC computer 14 in proximity of the data transfer device 125 (or 325) by for example saying “Please return me to my cave so I can take a nap,” or “let's play a game with the computer.” When the user positions an IC computer 14 such as, for example, a teddy bear in its cave (i.e., in the data transfer device 125, 325), user workstation 20 may automatically initiate communication with remote server 22. Since IC computer 14 has previously been initialized, communication application 331 may automatically begin the process of transferring interaction data from data storage device 217 without user input. The communication application 331 may, in turn, store interaction data. In addition, interactive analysis application 334 may generate information, which may include developmental results such as the number and percentage of correct and incorrect responses, social skills assessments, etc. Once the process is complete, communication application 331 may then automatically transfer program information such as new instructional and entertainment-related programming to user workstation 20.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

What is claimed is:

1. A method of providing customized companionship, educational and overall developmental experiences to a user, the method comprising:
a) creating a user account that includes a user identity, an identity of an intelligent companion computer and program information criteria;
b) receiving interaction data indicative of user interaction with the intelligent companion computer;
c) generating program information to modify the interactive behavior of the intelligent companion computer, wherein the program information is generated as a function of the interaction data and the program information criteria; and
d) transferring the program information to the intelligent companion computer.

2. The method of claim 1, wherein c) comprises manually modifying the generated program information prior to transfer to the intelligent companion computer.

3. The method of claim 1, wherein b) comprises:
storing interaction data representative of user inputs and corresponding interactive behavior of the intelligent companion computer in the intelligent companion computer; and
selectively transferring the interaction data.

4. The method of claim 1, further comprising e) tabulating the interaction data into developmental results, wherein the developmental results include at least one of reports and archive data indicative of at least one of educational testing results, cognitive learning results, personality trait assessments and social skill assessments.

5. The method of claim 1, further comprising e) storing the interaction data in association with the user account, wherein the interaction data includes at least one of the educational testing results, cognitive learning results, personality trait data and social skills data.

6. A method of providing customized companionship, educational and overall developmental experiences to a user, the method comprising:
a) storing program content in an intelligent companion computer;
b) operating at least one of audio and visual outputs of the intelligent companion computer as a function of the program content to interact with a user;
c) capturing inputs representative of interaction by the user with the intelligent companion computer;
d) analyzing the inputs and the corresponding at least one of audio and visual outputs; and
e) customizing the program content in the intelligent companion computer as a function of the analysis.

7. The method of claim 6, wherein c) comprises storing interaction data representative of the inputs and corresponding at least one of audio and visual outputs in the intelligent companion computer.

8. The method of claim 6, wherein c) comprises transferring interaction data representative of the inputs and corresponding at least one of audio and visual outputs over a network to a central computer for analysis.

9. The method of claim 6, wherein e) comprises:
automatically generating program information; and
selectively transferring the program information to the intelligent companion computer to modify the program content.

10. The method of claim 6, wherein e) comprises manually approving customization of the program content.

11. A method of providing customized companionship, educational and overall developmental experiences to a user, the method comprising:
a) programming the interactive behavior of an electronic toy, wherein the interactive behavior includes at least one of audio outputs and visual outputs;
b) interacting with the electronic toy for at least one of companionship, social skills and educational instruction;
c) capturing user inputs and corresponding interactive behavior of the electronic toy;
d) transferring the user inputs and corresponding interactive behavior of the electronic toy to a central computer;
e) analyzing the inputs in conjunction with corresponding interactive behavior of the electronic toy with the central computer; and
f) generating programming modifications with the central computer for the electronic toy, wherein the programming modifications customize the interactive behavior of the electronic toy to enhance development of the user, the programming modifications made as a function of the analysis of the user inputs and corresponding interactive behavior of the electronic toy.

12. The method of claim 11, wherein e) comprises generating developmental results indicative of at least one of educational development, behavioral development and social development of the user with the central computer.

13. The method of claim 11, wherein f) comprises an administrator of the user's development manually modifying the programming modifications generated by the central computer prior to transfer to the electronic toy.

14. The method of claim 11, wherein f) comprises the central computer generating programming modifications also as a function of program information criteria provided by an administrator of the development of the user.

15. The method of claim 11, further comprising g) transferring the programming modifications to the electronic toy upon approval by an administrator of the user.

16. A development system for providing companionship, educational and overall developmental experiences to a user, the development system comprising:
an intelligent companion computer operable to perform dynamically interactive outputs as a function of program content, wherein the intelligent companion computer is also operable to capture the dynamically interactive outputs and a corresponding user input as interaction data, the interaction data representative of interaction between a user and the intelligent companion computer; and
a central computer in selective communication with the intelligent companion computer, the central computer operable to receive and analyze the interaction data and generate corresponding program information, wherein the program information is transferable to the intelligent companion computer to customize the program content of the intelligent companion computer as a function of the interaction data.

17. The development system of claim 16, wherein the intelligent companion computer includes a communication adaptor for bi-directional communication with the central computer.

18. The development system of claim 16, wherein the intelligent companion computer includes at least one of a voice recognition module, input buttons, pressure pads, a display and a sensing device to capture the user input.

19. The development system of claim 16, wherein the intelligent companion computer includes a data storage device, the data storage device operable to store the interaction data.

20. The development system of claim 16, wherein the central computer includes a user workstation and a remote server, the user workstation operable to transfer the interaction data to the remote server for analysis and to transfer program information to the intelligent companion computer.

21. A development system for providing companionship, educational and overall developmental experiences to a user, the development system comprising:
an intelligent companion computer that includes program content operable to provide interactive behavior of the intelligent companion computer toward a user, wherein the intelligent companion computer is operable to store interaction data representative of interaction between the user and the intelligent companion computer;
a user workstation capable of selective communication with the intelligent companion computer, wherein the interaction data is transferable to the user workstation; and
a remote server in communication with the user workstation, wherein the interaction data is transferable to the remote server, the remote server operable to analyze the interaction data and generate program information, wherein the program information is transferable to the intelligent companion computer via the user workstation to customize the program content of the intelligent companion computer.

22. The development system of claim 21, wherein the user workstation is operable to convert program information to encoded data prior to transfer to the intelligent companion computer.

23. The development system of claim 21, wherein the user workstation is operable to access the remote server to modify the program information and approve transfer of the program information.

24. The development system of claim 21, wherein the intelligent companion computer is included in a stuffed toy.

25. The development system of claim 21, wherein the intelligent companion computer is a portable handheld electronic device.

26. The development system of claim 21, wherein the intelligent companion computer is operable in one of a stand alone mode and a data transfer mode, the data transfer mode operable when the intelligent companion computer is in communication with the user workstation.

27. The development system of claim 21, wherein the interaction data is representative of user inputs to the intelligent companion computer and corresponding interactive behavior of the intelligent companion computer.

28. A development system capable of providing customized companionship, educational and overall developmental experiences to a user, the method comprising:
instructions stored in a memory device to operate at least one of an audio output and a visual output of an intelligent companion computer to interact with a user;
instructions stored in the memory device to capture inputs representative of interaction by a user with the intelligent companion computer;
instructions stored in the memory device to analyze the inputs and corresponding outputs of the intelligent companion computer; and
instructions stored in the memory device to customize the interaction of the intelligent companion computer as a function of the analysis.

29. The development system of claim 28, further comprising instructions stored in the memory device to generate and store developmental results as a function of the analysis.

30. The development system of claim 28, further comprising instructions stored in the memory device to consider program information criteria provided by an administrator of the users development during customization.

31. The development system of claim 28, further comprising instructions stored in the memory device to allow modification and approval of customization of the interaction of the intelligent companion computer.

32. A development system for providing companionship, educational and overall developmental experiences to a user, the development system comprising:
an electronic toy programmed to behave interactively, wherein the electronic toy includes at least one of audio outputs and visual outputs to behave interactively, the electronic toy also includes capability to receive user inputs, the outputs and corresponding user inputs operable to provide interaction data indicative of interaction between a user and the electronic toy;
a data transfer device selectively coupled with the electronic toy; and
a central computer in communication with the data transfer device, wherein the electronic toy is operable to store and subsequently transfer the interaction data to the central computer system via the data transfer device, the central computer system operable to analyze the interaction data and transfer modifications of the programmed interactive behavior of the electronic toy, wherein the modifications customize the interactive behavior of the electronic toy to enhance development of the user, the modifications transferred to the electronic toy via the data transfer device.
